(19) United States
(12) Patent Application Publication
(10) Pub. No.: US 2024/0328142 A1
(43) Pub. Date: Oct. 3, 2024

(54) FLOW RESTRICTOR FOR A GREASE INTERCEPTOR

(71) Applicant: Advanced Drainage Systems, Inc., Hilliard, OH (US)

(72) Inventors: Paul HOLBROOK, Old Saybrook, CT (US); Alexander SHAIN, Lyme, CT (US); Adam MILLER, Haddam, CT (US)

(73) Assignee: Advanced Drainage Systems, Inc., Hilliard, OH (US)

(21) Appl. No.: 18/583,055

(22) Filed: Feb. 21, 2024

Related U.S. Application Data
(60) Provisional application No. 63/455,167, filed on Mar. 28, 2023.
(60) Provisional application No. 63/618,953, filed on Jan. 9, 2024.

(51) Int. Cl. E03F 5/16

(52) U.S. Cl. CPC E03F 5/16

(57) ABSTRACT

A grease interceptor for use with a wastewater treatment system comprises a tank which is divided by a baffle into a first chamber and a second chamber. Wastewater flows from an inflow pipe into a first chamber of the tank. The wastewater may then flow through openings in the baffle to a second chamber of the tank. The wastewater may then flow through an outlet pipe in the second chamber to exit the system. The inflow pipe may comprise a flow restrictor which may restrict the flow of wastewater within the inflow pipe.

### CROSS REFERENCE TO RELATED APPLICATIONS

This application claims benefit of priority of U.S. Provisional Patent Application No. 63/455,167 filed Mar. 28, 2023, and U.S. Provisional Patent Application No. 63/618,953 filed Jan. 9, 2024. The content of the foregoing applications is incorporated herein by reference in their entirety.

### TECHNICAL FIELD

This disclosure relates generally to systems, apparatuses, and methods for treating wastewater through a grease interceptor system, and, more particularly, to treating wastewater through the use of adjustable or non-adjustable flow restrictors within a grease interceptor system.

### BACKGROUND

Wastewater from a dwelling or commercial building is often treated by either an onsite subsurface system or by a community or municipal sewer system. A typical onsite system may comprise a septic tank within which solids settle out of the wastewater and anaerobic treatment of the wastewater takes place. The wastewater may then flow to a leach field for aerobic treatment. A typical municipal system may comprise an interconnected array of lateral sewer lines and mains connected to a mechanical and biological treatment system.

A common source of wastewater may be a restaurant or other food preparation facility where the wastewater may be largely from sinks and dishwashing machines. Such wastewater tends to contain a considerable quantity of contaminants, such as fats, oil, and grease. Removal of contaminants from the wastewater is required by municipal sewer systems regulations or to enable optimal septic tank functioning, as applies. Thus, a familiar practice is to first flow the source wastewater through a grease interceptor or grease trap.

Grease interceptor systems process wastewater to remove contaminants such as fats, oils, and grease. These systems may be used to separate contaminants from wastewater discharge flowing from kitchen or other food service waste streams. These systems temporarily store and divert wastewater streams for removal of contaminants before discharging filtered wastewater into the municipal sewer systems or septic tanks. Typically, a grease interceptor will be buried within the soil that is adjacent to the building that generates the wastewater. Alternatively, a grease interceptor may be located within a building interior space. Thus, it is desirable that grease interceptors be both efficient and compact.

In operation, a grease interceptor may comprise a tank that has a baffle or transverse wall that nominally divides the length of the tank into two chambers, typically of equal sizes. During grease interceptor operation, there is a net downstream flow of wastewater through the grease interceptor system. The baffle may impede flow of contaminants from the grease interceptor first chamber into the grease interceptor second chamber. Contaminants, which are typically lighter than water, may float to the top of the wastewater in the first chamber. Solids and semi-solids that may be present in the wastewater stream may sink to the bottom of the first chamber. Some anaerobic conversion of the contaminants and solids may also take place within the grease interceptor.

A typical grease interceptor baffle may have one or more openings at about mid-elevation, enabling relatively clear water to flow from the first chamber into the second chamber, where further separation of grease and oil may occur. Wastewater may then flow from the second chamber to a grease interceptor outlet that is in flow communication with a sewer system or a septic tank. Regulatory requirements often mandate the amount of grease and oil that may be present in the wastewater discharged to a municipal sewer system. Periodically, closures on the top of the grease interceptor are opened to remove accumulated contaminants. Thus, a greater oil and grease storage capacity of a grease interceptor may result in less frequent and lower cost periodic cleanings.

The inflow pipe of the grease interceptor system may comprise a horizontal pipe and a vertical pipe joined at an elbow junction. The horizontal pipe of the inflow pipe may extend axially through a front wall of the grease interceptor system to the elbow junction within the first chamber of the grease interceptor system. The vertical pipe may extend downward from the junction with a discharge opening within the first chamber of the grease interceptor system. Wastewater containing contaminants may flow into the grease interceptor system through the horizontal pipe towards the elbow joint and down through the vertical pipe into the first chamber of the grease interceptor system. Adjustable or non-adjustable flow restrictors may be placed in the vertical pipe of the inflow pipe to control the flow of wastewater into the first chamber of the grease interceptor system.

Solutions are needed to provide improved grease interceptor systems. Such solutions may include the use of adjustable or non-adjustable flow restrictors in the inflow pipe of the grease interceptor system to control and moderate the flow of wastewater into the grease interceptor system. These solutions may allow for a more compact and efficient grease interceptor system.

### SUMMARY

The disclosed embodiments describe systems, methods, and devices for an adjustable flow restrictor in a grease interceptor system. These systems, methods, and devices may include an adjustable flow restrictor configured to regulate a flow of wastewater through an inflow standpipe of a grease interceptor. For example, in an embodiment, the adjustable flow restrictor may comprise a rotatable cap, wherein the rotatable cap may comprise at least one handle configured to adjust the rotatable cap within the inflow standpipe, and a flow restrictor projection extending from the rotatable cap into the inflow standpipe, wherein the flow restrictor projection may comprise a curved projection configured to restrict the flow of wastewater within the inflow standpipe. In some embodiments, the rotatable cap may further comprise a flow restriction indicator arrow which may be configured to indicate a degree of flow restriction caused by the flow restrictor projection. In other embodiments, the flow restriction indicator arrow may correspond to a flow restriction percentage indicator on the inflow standpipe. In some embodiments, the flow restriction percentage indicator may comprise numbers, dashes, notches, or shapes.

In some embodiments, the rotatable cap may further comprise a cap lock configured to secure the adjustable flow restrictor within an inflow standpipe lock. In other embodiments, the inflow standpipe lock may comprise a channel extending around an interior circumference of the inflow standpipe. In other embodiments, the rotatable cap may comprise two handles. In some embodiments, a diameter of the rotatable cap may correspond to a diameter of the inflow standpipe. In other embodiments, a diameter of the flow restrictor projection may correspond to a diameter of the inflow standpipe. In some embodiments, the flow restrictor projection may extend around an interior circumference of the inflow standpipe.

The disclosed embodiments may further include a grease interceptor for treating wastewater by separating and retaining contaminants. In some embodiments, the grease interceptor may comprise a tank having a top wall, a bottom wall, opposing side walls, an upstream end wall, a downstream end wall, a baffle extending transversely between the opposing side walls, dividing the tank lengthwise into a first chamber and a second chamber, wherein the baffle comprises at least one exit opening for discharge of wastewater from the first chamber into the second chamber, an inflow pipe configured to direct wastewater from a source through an inflow standpipe to the first chamber, an adjustable flow restrictor comprising a rotatable cap and a flow restrictor projection configured to regulate a flow of wastewater into the inflow standpipe, and an outlet pipe configured to direct wastewater from the second chamber through an outlet standpipe to an outlet.

In some embodiments, the rotatable cap of the adjustable flow restrictor may further comprise a flow restriction indicator arrow configured to indicate a degree of flow restriction caused by the flow restrictor projection. In other embodiments, the flow restriction indicator arrow may correspond to a flow restriction percentage indicator on the inflow standpipe. In some embodiments, the flow restriction percentage indicator may comprise numbers, dashes, notches, or shapes. In other embodiments, the rotatable cap may further comprise a cap lock configured to secure the adjustable flow restrictor within an inflow standpipe lock. In some embodiments, the inflow standpipe lock may comprise a channel extending around an interior circumference of the inflow standpipe. In some embodiments, the cap lock of the adjustable flow restrictor may be configured to rotate within the channel of the inflow standpipe lock to adjust a level of flow restriction of the adjustable flow restrictor. In other embodiments, the flow restrictor projection may extend around an interior circumference of the inflow standpipe. In some embodiments, a diameter of the rotatable cap may correspond to a diameter of the inflow standpipe. In other embodiments, a diameter of the flow restrictor projection may correspond to a diameter of the inflow standpipe.

The disclosed embodiments may further comprise systems, methods, and devices for a non-adjustable flow restrictor in a grease interceptor system. These systems, methods, and devices may include a non-adjustable flow restrictor configured to regulate a flow of wastewater through an inflow standpipe of a grease interceptor. The non-adjustable flow restrictor may comprise a curved projection configured to restrict a flow of wastewater from an inflow pipe to the inflow standpipe, and one or more one-way snap locks on a perimeter of the non-adjustable flow restrictor configured to secure the non-adjustable flow restrictor within the inflow standpipe. In some embodiments, the inflow standpipe may further comprise one or more connection openings configured to secure the plurality of one-way snap locks. In other embodiments, the non-adjustable flow restrictor may comprise four one-way snap locks. In some embodiments, the inflow standpipe may comprise four connection openings. In other embodiments, a size and spacing of the one or more one-way snap locks may correspond to a size and spacing of the one or more connection openings. In some embodiments, the one or more one-way snap locks may not be removeable from the one or more connection openings after installation. In other embodiments, the non-adjustable flow restrictor may further comprise a removeable cap configured for installation over the inflow standpipe. In some embodiments, a diameter of the non-adjustable flow restrictor may correspond to an inner diameter of the inflow standpipe.

The disclosed embodiments may further comprise systems, methods, and devices for a rotatable flow restrictor in a grease management system. These systems, methods, and devices may include a rotatable flow restrictor configured to regulate a flow of wastewater through an inflow standpipe. The rotatable flow restrictor may comprise a rotation cap installed on a perimeter of the inflow standpipe to secure the rotatable flow restrictor within the inflow standpipe, a flow restrictive projection extending from the rotation cap, wherein the flow restrictive projection extends into an opening of the inflow standpipe, an open flow projection extending from the rotation cap, wherein the open flow projection is located above the opening of the inflow standpipe, and at least one rotation knob configured to facilitate the rotation of the rotatable flow restrictor within the inflow standpipe. In some embodiments, the flow of wastewater may be restricted by rotating the flow restrictive projection to extend into the opening of the inflow standpipe. In some embodiments, the flow of wastewater may be unrestricted by rotating the open flow projection over the opening of the inflow standpipe. In some embodiments, the rotatable flow restrictor may comprise two rotation knobs. In some embodiments, the at least one rotation knob may comprise a projection from an inner surface of the rotatable flow restrictor. In some embodiments, the at least one rotation knob may be semi-circular, elliptical, square, or rectangular in shape. In other embodiments the rotatable flow restrictor may further comprise a removeable cap configured for installation over the inflow standpipe. In some embodiments, a diameter of the rotatable flow restrictor may correspond to a diameter of the inflow standpipe. In other embodiments, the rotatable flow restrictor may not be removeable from the inflow standpipe after the rotation cap is installed on the perimeter of the inflow standpipe. In some embodiments, the rotatable flow restrictor may be rotated within the inflow standpipe through use of an adjustment tool corresponding to the rotation knobs. In other embodiments, the rotatable flow restrictor may comprise at least one male detent feature and at least one female detent feature configured to prevent rotation of the rotatable flow restrictor after adjustment. In some embodiments, the rotatable flow restrictor may comprise two male detent features and two female detent features.

The disclosed embodiments may further comprise systems, methods, and devices for an adjustable flow restrictor plate in a grease interceptor system. These systems, methods, and devices may include an adjustable flow restrictor plate configured to regulate a flow of wastewater through an inflow standpipe. The adjustable flow restrictor plate may comprise a horizontal extension extending from the inflow standpipe, a flow restrictor plate extension extending vertically from the horizontal extension, and a flat plate configured for installation within the flow restrictor plate extension of the horizontal extension of the inflow standpipe. In some embodiments, the horizontal extension may comprise a pipe extending horizontally from the inflow standpipe. In other embodiments, the horizontal extension may further comprise a cutout corresponding to the flow restrictor plate extension to facilitate the movement of the adjustable flow restrictor plate within the horizontal extension. In some embodiments, a size of the adjustable flow restrictor plate may correspond to a size of the flow restrictor plate extension. In other embodiments, the flow restrictor plate extension may comprise a hollow vertical extension from the horizontal extension of the inflow standpipe. In some embodiments, the adjustable flow restrictor plate may be raised or lowered within the flow restrictor plate extension to regulate a flow of wastewater within the inflow standpipe. In other embodiments, an inflow pipe may be connected to the horizontal extension to facilitate a flow of wastewater from a source to the inflow standpipe.

The disclosed embodiments may further comprise systems, methods, and devices for a non-adjustable flow restrictor plate in a grease interceptor system. These systems, methods, and devices may include a non-adjustable flow restrictor plate configured to regulate a flow of wastewater through an inflow standpipe of a grease interceptor. For example, in some embodiments, the non-adjustable flow restrictor plate may comprise an inflow standpipe adapter configured for connection to a horizontal extension from the inflow standpipe, an inflow pipe adapter configured for connection to an inflow pipe, and a flat plate with a flow restriction opening configured for installation between the inflow standpipe adapter and the inflow pipe adapter. In some embodiments, the flow restriction opening may comprise a diameter that is less than a diameter of an opening in the inflow standpipe adapter. In other embodiments, the inflow standpipe adapter may comprise a slotted edge configured to retain the non-adjustable flow restrictor plate. In some embodiments, the inflow standpipe adapter may comprise an opening. In some embodiments, a diameter of the opening of the inflow standpipe adapter may correspond to a diameter of the horizontal extension.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 is a perspective view of a grease interceptor system, consistent with various embodiments of the present disclosure.

FIG. 2 is a section cut of the grease interceptor system of FIG. 1, consistent with various embodiments of the present disclosure.

FIG. 3 is a view of the baffle of FIG. 1 showing the side of the baffle that faces upstream when installed within a grease interceptor tank, consistent with various embodiments of the present disclosure.

FIG. 4 is a view of the baffle of FIG. 1 showing the side of the baffle that faces downstream when installed within a grease interceptor tank, consistent with various embodiments of the present disclosure.

FIG. 5 is a perspective view of the upstream side of the baffle of FIG. 1 depicting a flow of wastewater through the grease interceptor system, consistent with various embodiments of the present disclosure.

FIG. 6 is a perspective view of the downstream side of the baffle of FIG. 1 depicting a flow of wastewater through the grease interceptor system, consistent with various embodiments of the present disclosure.

FIG. 7 is an example of an adjustable flow restrictor for installation within a grease interceptor inflow standpipe, consistent with various embodiments of the present disclosure.

FIG. 8 is an example of an adjustable flow restrictor installed within a grease interceptor inflow standpipe, consistent with various embodiments of the present disclosure.

FIG. 9 is a section cut of an adjustable flow restrictor installed within a grease interceptor inflow standpipe, consistent with various embodiments of the present disclosure.

FIG. 10A is an adjustable flow restrictor in a fully open position within a grease interceptor inflow standpipe, consistent with various embodiments of the present disclosure.

FIG. 10B is an example of a cap of an adjustable flow restrictor in a fully opened position within a grease interceptor inflow standpipe, consistent with various embodiments of the present disclosure.

FIG. 11A is an adjustable flow restrictor in an 80% closed position within a grease interceptor inflow standpipe, consistent with various embodiments of the present disclosure.

FIG. 11B is an example of a cap of an adjustable flow restrictor in an 80% closed position within a grease interceptor inflow standpipe, consistent with various embodiments of the present disclosure.

FIG. 12 is a section cut of a non-adjustable flow restrictor installed within a grease interceptor inflow standpipe, consistent with various embodiments of the present disclosure.

FIG. 13 is a section cut of a non-adjustable flow restrictor installed within a grease interceptor inflow standpipe with the cap removed, consistent with various embodiments of the present disclosure.

FIG. 14 is a section cut of a grease interceptor inflow standpipe with connection openings, consistent with various embodiments of the present disclosure.

FIG. 15 is a section cut of a grease interceptor inflow standpipe with connection openings, consistent with various embodiments of the present disclosure.

FIG. 16 is a section cut of a rotatable flow restrictor installed within a grease interceptor inflow standpipe, consistent with various embodiments of the present disclosure.

FIG. 17 is a section cut of a rotatable flow restrictor installed in a flow restrictive position within a grease interceptor inflow standpipe, consistent with various embodiments of the present disclosure.

FIG. 18 is a section cut of a rotatable flow restrictor installed in an open flow position within a grease interceptor inflow standpipe, consistent with various embodiments of the present disclosure.

FIG. 19 is an adjustment tool for use with a rotatable flow restrictor installed within a grease interceptor inflow standpipe, consistent with various embodiments of the present disclosure.

FIG. 20 is an adjustable flow restrictor pipe installed within a grease interceptor inflow standpipe, consistent with various embodiments of the present disclosure.

FIG. 21 is a non-adjustable flow restrictor plate for installation within a grease interceptor inflow standpipe, consistent with various embodiments of the present disclosure.

### DETAILED DESCRIPTION

Examples of embodiments of the present disclosure are described with reference to the accompanying drawings. In the figures, which are not necessarily drawn to scale, wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It should also be noted that as used in the present disclosure and in the appended claims, the singular forms “a,” “an,” and “the” include plural references unless the context clearly dictates otherwise.

A need has been recognized to provide an efficient and compact grease interceptor system that allows for control of the flow of wastewater into the grease interceptor system. Existing grease interceptor systems may not effectively separate contaminants from the wastewater stream and may be too large for efficient underground installation. Existing grease interceptor systems may also include a flow restrictor in the inflow pipe. However, such existing flow restrictors may not be adjustable after the flow restrictor has been installed within the inflow pipe of the grease interceptor system. Additionally, existing flow restrictors may be difficult to clean after installation.

The disclosed embodiments improve these and other deficiencies in existing grease interceptor systems. For example, solutions are provided to allow for a compact and efficient grease interceptor system that maximizes the amount of contaminants separated from the flow of wastewater. The disclosed embodiments comprise a grease interceptor tank separated by a baffle into two chambers to allow for separation of contaminants from the flow of wastewater between the first chamber and the second chamber. Additionally, solutions are provided to allow for control of the flow of wastewater into the grease interceptor system. The disclosed embodiments comprise adjustable and non-adjustable flow restrictors that may regulate the flow of wastewater from an inflow pipe into an inflow standpipe. Such flow restrictors may allow for easy access to the inflow standpipe to facilitate cleaning and maintenance of the inflow standpipe assembly.

References will now be made in detail to the disclosed embodiments, examples of which are illustrated in the accompanying drawings.

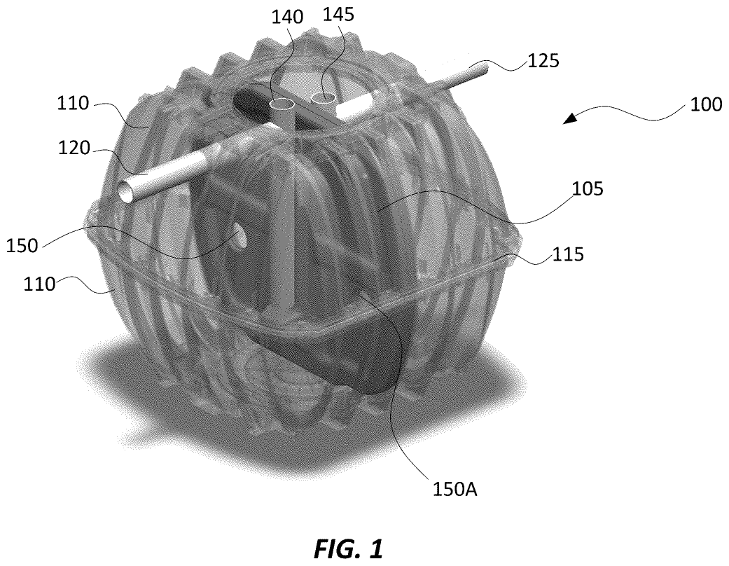

FIG. 1 depicts a perspective view of a grease interceptor 100. Grease interceptor 100 may be made of molded polypropylene or polyethylene components. Grease interceptor 100 and its associated baffle 105 may alternatively comprise a material other than polypropylene or polyethylene; for instance, other polymers, fiberglass reinforced polyester resin, or concrete. Baffle 105 may be made by thermoforming two sheets and joining them to each other along a y-z plane (horizontal plane) joint. Baffle 105 may also be made by blow molding a parison within a mold.

The tank of grease interceptor 100 may comprise two identical half tanks 110, each having a flange that is mated at joint 115 by clamping, welding, adhesion, or any other method of mating suitable for connecting half tanks 110. When installed, grease interceptor 100 may comprise a top wall, a bottom wall, opposing side walls, an upstream end wall, and a downstream end wall. The top wall of the upper half tank 110 may have access ports for maintenance (not shown). The configuration of baffle 105, inflow standpipe 140, and outflow standpipe 145 may allow for access to these components for cleaning and maintenance through only one manhole.

Grease interceptor 100 may additionally comprise baffle 105. Baffle 105 may have a hollow interior with no provisions for flow through the hollow interior (concavity). Baffle 105 may be installed within the corrugations of the interior of the sidewalls of the tank, thus dividing the interior of the tank into two chambers. Baffle 105 may further comprise openings 150 and 150A, which may allow for the flow of wastewater between the two chambers.

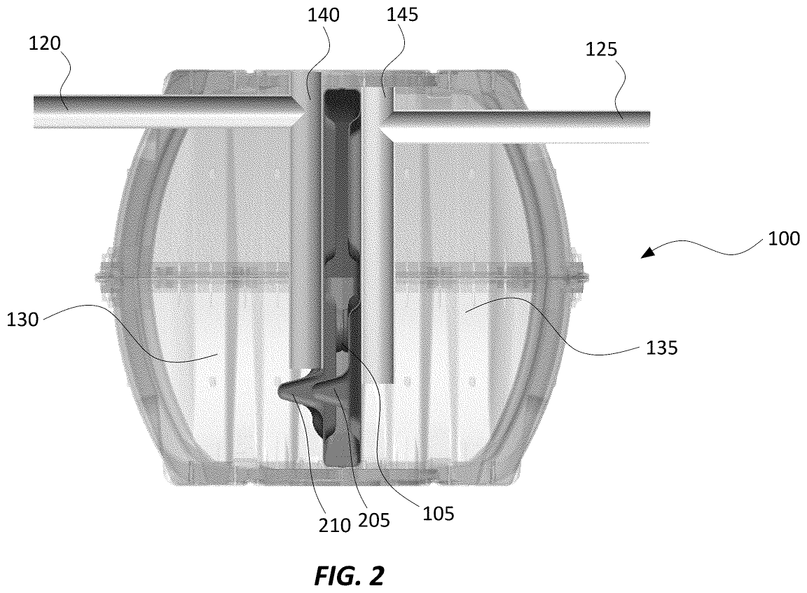

Grease interceptor 100 may further comprise an inflow pipe 120 and an outflow pipe 125. Inflow pipe 120 may extend through the upstream end wall of grease interceptor 100 and carry wastewater from a source to an inflow standpipe 140 configured to direct the flow of wastewater to a lower portion of a first chamber 130, as shown in FIG. 2, which depicts a section cut of grease interceptor 100 containing baffle 105. Wastewater may then flow from first chamber 130 to a second chamber 135 through openings 150 and 150A in baffle 105. Outflow pipe 125 may extend through the downstream end wall of grease interceptor 100. The flow of wastewater may be directed through outflow standpipe 145 and outflow pipe 140 to exit the second chamber 135 of grease interceptor 100.

As depicted in FIG. 2, baffle 105 may further comprise an internal protrusion 205 and an external protrusion 210. Internal protrusion 205 may comprise a hollow extension that extends from the face of the downstream side of baffle 105 into the hollow interior of baffle 105. External protrusion 210 may comprise a hollow extension that extends from the face of the upstream side of baffle 105 away from the hollow interior of baffle 105. Internal protrusion 205 and external protrusion 210 may facilitate the secure stacking of multiple baffles 105 for storage or transportation. For example, the external protrusion 210 of baffle 105 may be placed within the interior protrusion of a second baffle to allow a plurality of baffles to be securely stacked.

As further depicted in FIG. 2, baffle 105 may divide the tank into first chamber 130 and second chamber 135. Inflow pipe 120 may accept a flow of wastewater from a source and the wastewater may be directed through inflow pipe 120 and inflow standpipe 140 into first chamber 130. While wastewater is contained in first chamber 130, contaminants, such as fats, oils, and grease, may float upward and accumulate at the surface of the wastewater. Heavier-than-water solids may sink and accumulate as an aggregation at the bottom of first chamber 130. Wastewater may then flow through openings 150 and 150A of baffle 105 from first chamber 130 into second chamber 135.

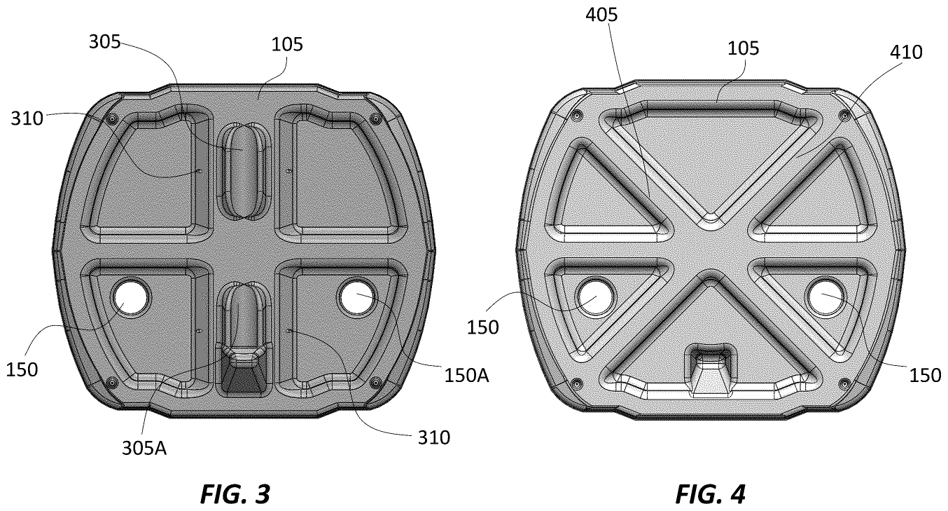

FIG. 3 depicts the upstream side of baffle 105 and FIG. 4 depicts the downstream side of baffle 105. The upstream side of baffle 105 may comprise pipe supports 305 and 305A. Pipe supports 305 and 305A may comprise extrusions in the face of upstream side of baffle 105 and may accept a pipe such as inflow standpipe 140. Pipe supports 305 and 305A may support a pipe such as inflow standpipe 140 to prevent movement of inflow standpipe 140 during operation of grease interceptor 100. The upstream side of baffle 105 may also comprise a plurality of zip tie holes 310 adjacent to pipe supports 305 and 305A. During installation of baffle 105, inflow standpipe 140 may be placed within pipe supports 305 and 305A and zip ties may be used to secure inflow standpipe 140 to the upstream side of baffle 105 using the plurality of zip tie holes 310. As depicted in FIGS. 3 and 4, baffle 105 may further comprise openings 150 and 150A. Openings 150 and 150A may allow wastewater to flow from first chamber 130 to second chamber 135 of the grease interceptor 100. Generally, openings 150 and 150A may be below the mid-elevation of a height of baffle 105. The mid-elevation may be nominally half of the height of the baffle 105. The downstream side of baffle 105 may comprise a first diagonal protrusion 405 and a second diagonal protrusion 410. First diagonal protrusion 405 and second diagonal protrusion 410 may extend vertically from the face of the downstream side of baffle 105 to provide strength and structural support to baffle 105.

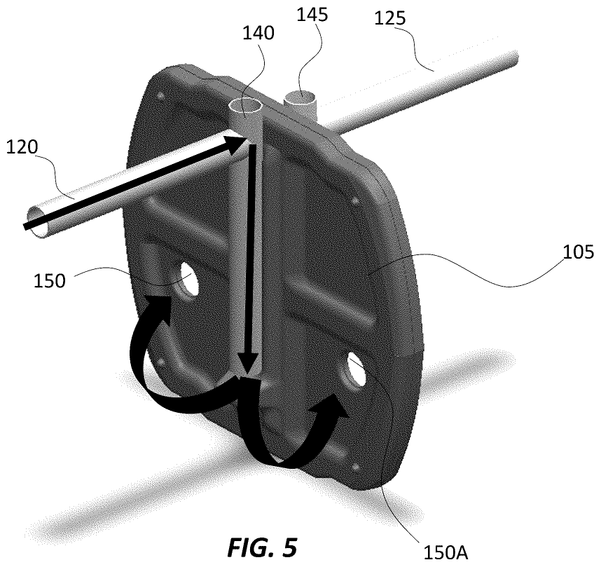

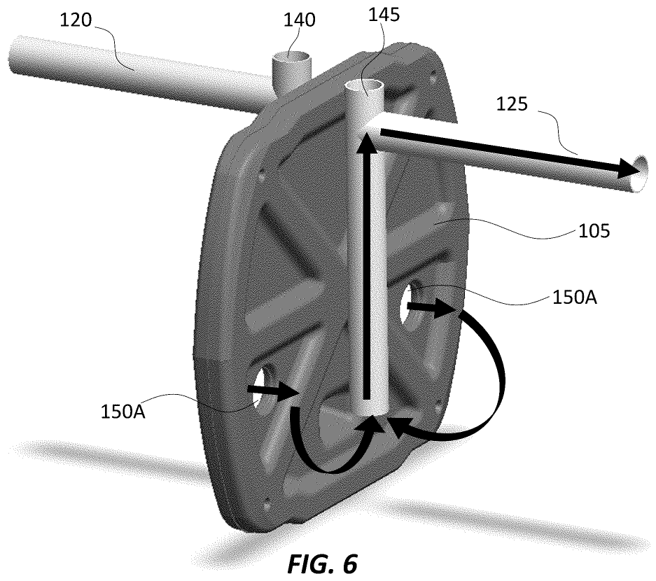

FIGS. 5 and 6 depict the flow of wastewater through grease interceptor 100, with the grease interceptor tank removed for clarity. As depicted in FIG. 5, wastewater may flow from a source through inflow pipe 120 to inflow standpipe 140. Inflow standpipe 140 may direct the flow of wastewater to the lower portion of first chamber 130 (depicted in FIG. 2). Within the first chamber 130, there may be a swirling and then slowing motion of the water, enabling oil and grease to float upward and accumulate at the surface of the water in first chamber 130. Heavier-than-water solids may also sink and accumulate as an aggregation at the bottom of first chamber 130. Wastewater may then flow through openings 150 and 150A of baffle 105 from first chamber 130 to second chamber 135, as depicted in FIG. 2.

As depicted in FIG. 6, wastewater may flow into second chamber 135 (depicted in FIG. 2) through openings 150 and 150A of baffle 105. The oil and grease that remains in the wastewater flowing into second chamber 135 may accumulate near the surface of water in second chamber 135. Any heavier-than-water solids may also accumulate at the bottom of second chamber 135. Wastewater may then flow upwardly through outflow standpipe 145 to outflow pipe 125 which may be in flow communication with a municipal sewer line or a septic tank inlet (not shown in FIG. 6).

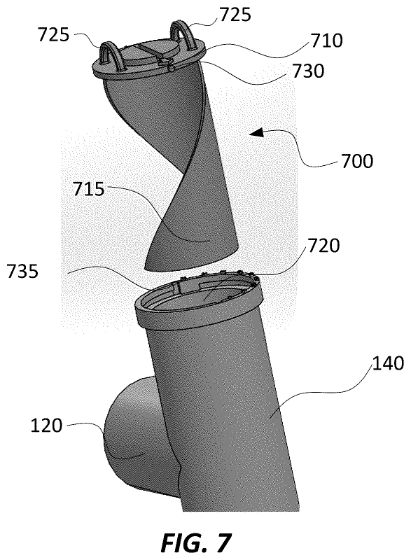

FIGS. 7-9, 10A-B, and 11A-B depict embodiments of an adjustable flow restrictor 700 which may be installed within inflow standpipe 140 to control the flow of wastewater into grease interceptor 100. Adjustable flow restrictor 700 may be removed from inflow standpipe 140 after installation and may be rotated within inflow standpipe 140 after installation to adjust the level of flow restriction resulting from adjustable flow restrictor 700.

FIG. 7 depicts an example of an adjustable flow restrictor 700 for installation within an inflow standpipe, such as inflow standpipe 140. Adjustable flow restrictor 700 may regulate the flow of wastewater from a waste stream into the grease interceptor 100. The degree of regulation of the flow of wastewater may be adjusted by an end user after adjustable flow restrictor 700 has been installed within inflow standpipe 140. Further, adjustable flow restrictor 700 may be removeable from inflow standpipe 140 to allow for cleaning and maintenance.

Adjustable flow restrictor 700 may comprise a cap 710 and a flow restrictor projection 715. Cap 710 may comprise an upper portion of adjustable flow restrictor 700 which may fit within inflow standpipe opening 720. A diameter of cap 710 may correspond to a diameter of inflow standpipe 140 such that cap 710 may be installed within inflow standpipe opening 720. Cap 710 may aid in the installation and removal of adjustable flow restrictor 700 within inflow standpipe 140 and may block the flow of wastewater from exiting inflow standpipe 140 through inflow standpipe opening 720. Cap 710 may further comprise at least one handle 725. As depicted in FIG. 7, cap 710 may comprise two handles 725. Handles 725 may be used to place adjustable flow restrictor 700 within inflow standpipe 140 during installation. Handles 725 may also be used to adjust an orientation of adjustable flow restrictor 700 within inflow standpipe 140 after installation. Handles 725 may also be used to remove adjustable flow restrictor 700 from inflow standpipe 140 for cleaning and maintenance. Cap 710 may further comprise at least one cap lock 730. Cap lock 730 may comprise an extrusion from the side surface of cap 710. Cap lock 730 may secure adjustable flow restrictor 700 within corresponding inflow standpipe lock 735 of inflow standpipe 140 and facilitate rotation of adjustable flow restrictor 700 within inflow standpipe 140 after installation. The size and shape of cap lock 730 may correspond to the size and shape of standpipe lock 735 such that cap lock 730 may be installed and rotated within standpipe lock 735.

Adjustable flow restrictor 700 may further comprise flow restrictor projection 715. Flow restrictor projection 715 may comprise a projection that extends from a bottom surface of cap 710 into inflow standpipe 140. Flow restrictor projection 715 may block the flow of wastewater as it flows from inflow pipe 120 into inflow standpipe 140. Flow restrictor projection 715 may comprise a curved circular surface. A diameter of flow restrictor projection 715 may correspond to a diameter of inflow standpipe 140, such that flow restrictor projection 715 may fit within and extend around the interior circumference of inflow standpipe 140. An orientation of the curved circular surface of flow restrictor projection 715 within inflow standpipe 140 may correspond to an amount of restriction in the flow of wastewater from inflow pipe 120 to inflow standpipe 140. The flow restriction of wastewater within inflow standpipe 140 may be adjusted any time after installation of adjustable flow restrictor 700 by rotating cap 710 to adjust the orientation of flow restrictor projection 715 within inflow standpipe 140. By rotating cap 710, more or less of the curved circular surface of flow restrictor projection 715 may block the intersection of inflow pipe 120 and inflow standpipe 140, thus increasing or decreasing the flow of wastewater into inflow standpipe 140.

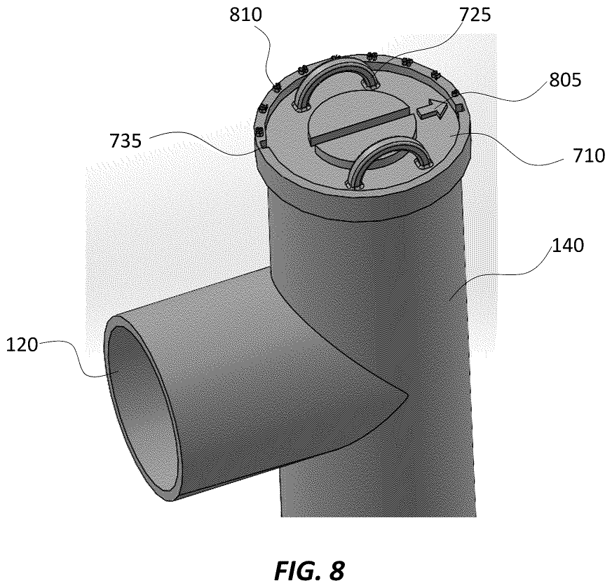

FIG. 8 depicts adjustable flow restrictor 700 installed within inflow standpipe 140. Cap 710 may fit within inflow standpipe 140 to block the flow of wastewater from exiting through inflow standpipe opening 720 (shown in FIG. 7) during operation of grease interceptor 100. Cap 710 may further comprise a flow restriction indicator arrow 805 on the top surface of cap 710. The top surface of inflow standpipe 140 may comprise corresponding flow restriction percentage indicators 810. The flow restriction percentage indicators 810 may comprise numbers ranging from zero to one hundred. The flow restriction percentage indicators 810 correspond to the degree to which adjustable flow restrictor 700 is restricting wastewater flow from entering inflow standpipe 140. In some embodiments, restriction percentage indicators 810 may comprise dashes, notches, shapes, or any other suitable indicator. Inflow standpipe 140 may further comprise inflow standpipe lock 735. Inflow standpipe lock 735 may comprise a cutout in the inner perimeter of inflow standpipe 140 that may correspond to cap lock 730. Cap lock 730 may be installed within inflow standpipe lock 735 to secure adjustable flow restrictor 700 within inflow standpipe 140. Additionally, inflow standpipe lock 735 may provide a channel around an interior circumference of inflow standpipe 140 within which cap lock 730 may be rotated to allow for post-installation changes in the positioning of adjustable flow restrictor 700.

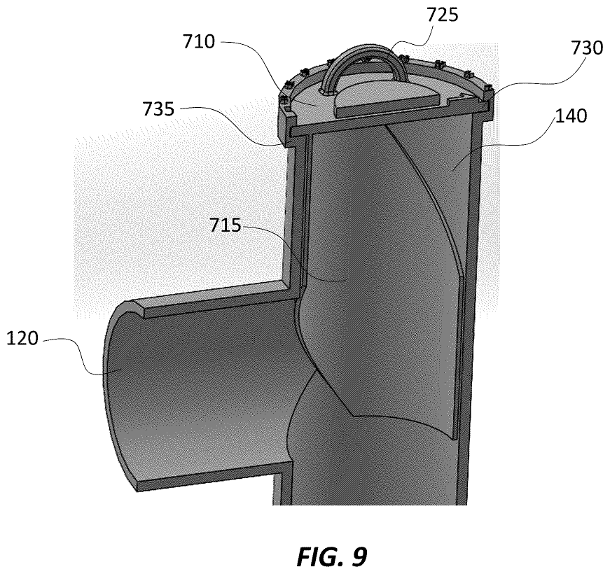

FIG. 9 depicts a section cut of adjustable flow restrictor 700 installed within inflow standpipe 140. As depicted in FIG. 9, the curved circular surface of flow restrictor projection 715 may extend around an inner circumference of inflow standpipe 140. The curved shape of flow restrictor projection 715 allows adjustment of the degree of flow restriction between inflow pipe 120 and inflow standpipe 140. As depicted in FIG. 9, cap lock 730 may be locked within the channel of inflow standpipe lock 735. Cap lock 730, when installed within inflow standpipe lock 735, may also allow cap 710 to be rotated after installation of adjustable flow restrictor 700 to adjust the amount of flow restriction being caused by adjustable flow restrictor 700.

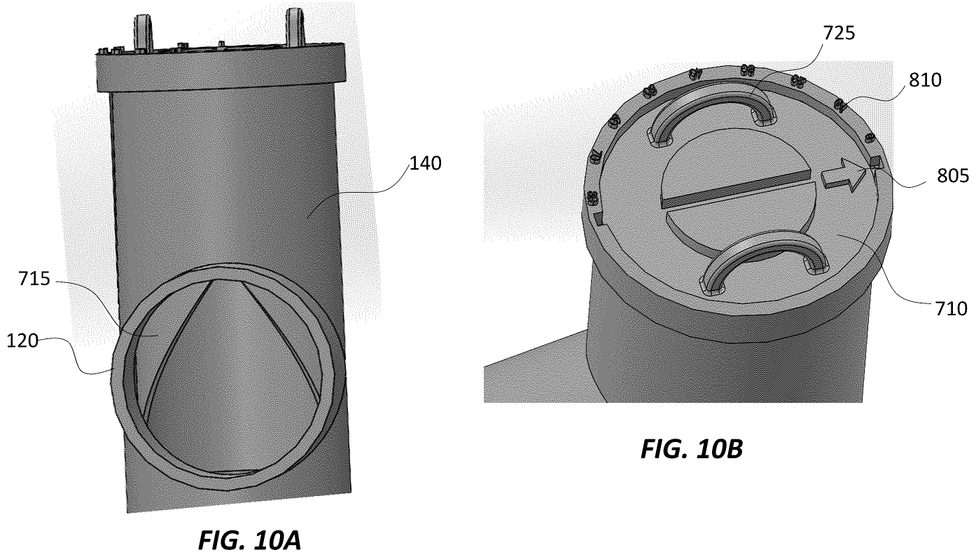

FIGS. 10A and 10B depict adjustable flow restrictor 700 installed within inflow standpipe 140 in a position that does not restrict the flow of wastewater from inflow pipe 120 to inflow standpipe 140. As depicted in FIG. 10A, flow restrictor projection 715 is placed within inflow standpipe 140 such that the curvature of flow restrictor projection 715 does not block the connection between inflow pipe 120 and inflow standpipe 140. Wastewater flowing through inflow pipe 120 may flow without restriction into inflow standpipe 140. As depicted in FIG. 10B, flow restriction indicator arrow 805 is near the “0” flow restriction percentage indicator 810. This positioning demonstrates that as cap 710 is installed, there is no flow restriction being caused by flow restrictor projection 715.

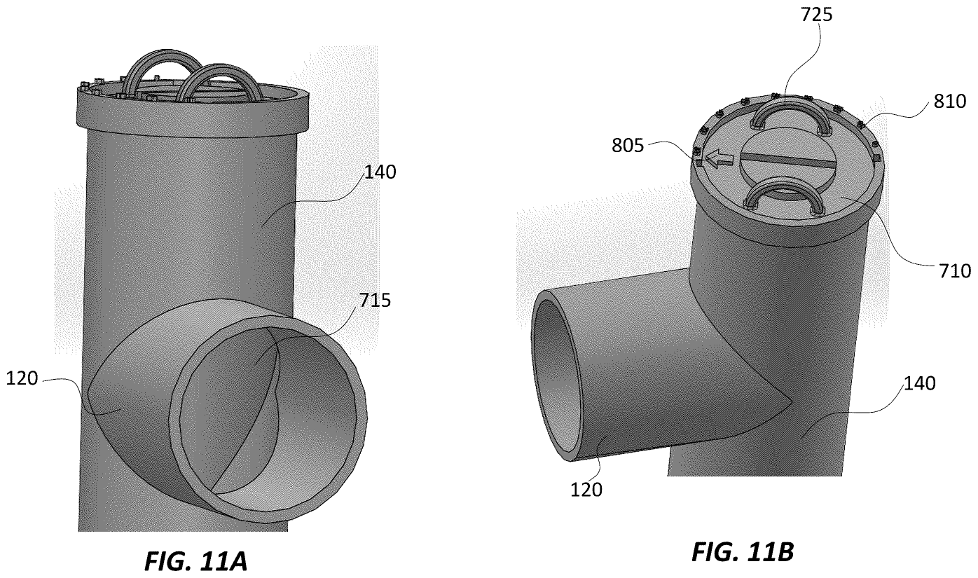

In comparison, FIGS. 11A and 11B depict adjustable flow restrictor 700 installed within inflow standpipe 140 in a position that restricts the flow of wastewater from inflow pipe 120 to inflow standpipe 140 by about 80%. As depicted in FIG. 11A, flow restrictor projection 715 is oriented within inflow standpipe 140 such that the curvature of flow restrictor projection 715 is blocking approximately 80% of the opening between inflow pipe 120 and inflow standpipe 140. Wastewater flowing through inflow pipe 120, therefore will be restricted when flowing into inflow standpipe 140. As depicted in FIG. 11B, flow restriction indicator arrow 805 is near the “80” flow restriction percentage indicator 810. This positioning demonstrates that adjustable flow restrictor 700 is positioned such that there is about 80% restriction of the flow of wastewater being caused by flow restrictor projection 715.

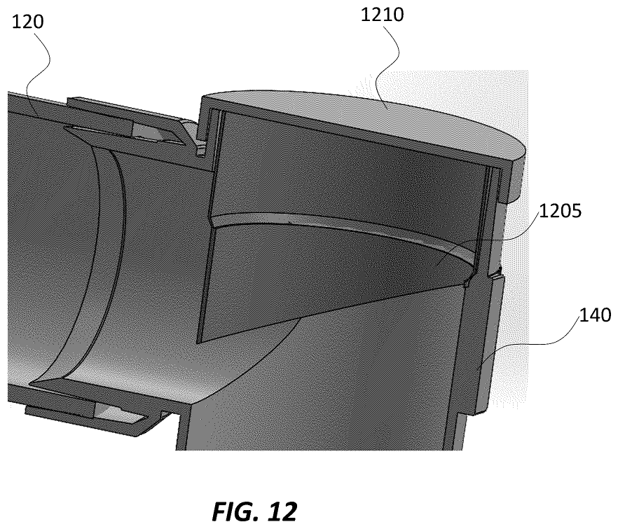

FIGS. 12-15 depict a non-adjustable flow restrictor 1205 which may be installed within inflow standpipe 140 to control the flow of wastewater into grease interceptor 100. Non-adjustable flow restrictor 1205 may not be removed from inflow standpipe 140 after installation and may not be adjusted within inflow standpipe 140 after installation.

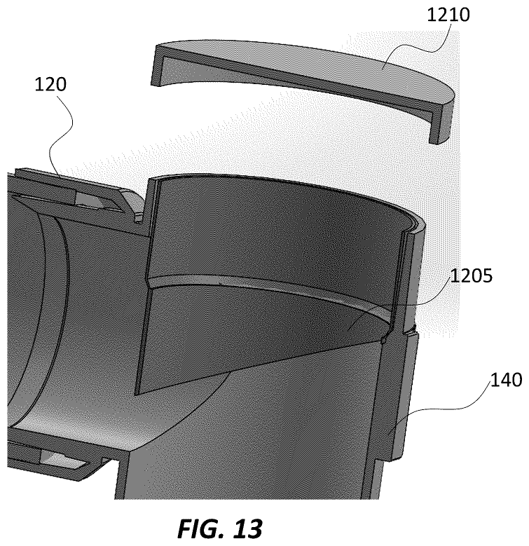

FIG. 12 depicts a section cut of a non-adjustable flow restrictor 1205 and cap 1210 installed in an inflow standpipe 140. Non-adjustable flow restrictor 1205 may comprise a curved circular surface that, when installed within inflow standpipe 140, may partially block the opening between inflow pipe 120 and inflow standpipe 140. The curved circular surface of non-adjustable flow restrictor 1205 may regulate and control the flow of wastewater from inflow pipe 120 to inflow standpipe 140. The diameter of non-adjustable flow restrictor 1205 may correspond to an inner diameter of inflow standpipe 140, such that non-adjustable flow restrictor 1205 may be installed within inflow standpipe 140. Cap 1210 may be placed over the opening of inflow standpipe 140 with a non-adjustable flow restrictor 1205 to prevent the flow of wastewater from exiting inflow standpipe 140 through the opening. In some embodiments, cap 1210 may be permanently position on non-adjustable flow restrictor and may not be removeable. FIG. 13 depicts a section cut of non-adjustable flow restrictor 1205 installed within inflow standpipe 140 with cap 1210 removed. In some embodiments, cap 1210 may be removeable to allow access to inflow standpipe 140 for cleaning and maintenance.

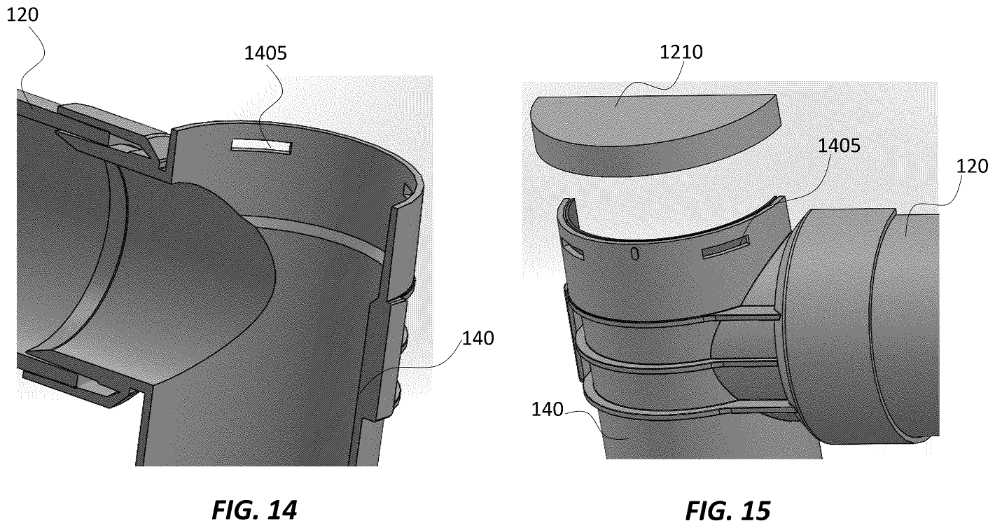

FIG. 14 depicts a section cut of inflow pipe 120 and inflow standpipe 140. A top portion of inflow standpipe 140 above inflow pipe 120 may contain one or more connection openings 1405. In some embodiments, inflow standpipe 140 may comprise four connection openings 1405. In other embodiments, inflow standpipe 140 may include any number of connection openings 1405. In some embodiments, connection openings 1405 may have different lengths and different heights. The one or more connection openings 1405 may accept a one-way snap lock on non-adjustable flow restrictor 1205 to secure non-adjustable flow restrictor 1205 within inflow standpipe 140. FIG. 15 depicts a section cut of a grease interceptor inflow standpipe with connection openings 1405. In the section cut depicted, two connection openings 1405 of inflow standpipe 140 are shown, however, if the complete inflow standpipe were depicted, four connection openings 1405 would be visible. Non-adjustable flow restrictor 1205 may be secured within inflow standpipe 140 through use of one-way snap locks that lock into the plurality of connection openings 1405. In such an embodiment, non-adjustable flow restrictor 1205 may not be removed from inflow standpipe 140 or adjusted within inflow standpipe 140 after non-adjustable flow restrictor has been installed within inflow standpipe 140. As depicted in FIG. 15, cap 1210 may be removeable to allow access to inflow standpipe 140 for cleaning and maintenance.

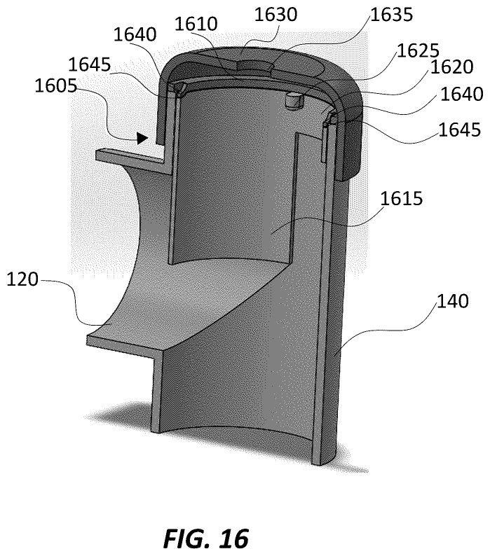

FIGS. 16-19 depict a rotatable flow restrictor 1605 which may be installed within inflow standpipe 140 to regulate the flow of wastewater from inflow pipe 120 to inflow standpipe 140. Rotatable flow restrictor 1605 may not be removeable from inflow standpipe 140 after installation, but rotatable flow restrictor 1605 may be rotated within inflow standpipe 140 after installation to adjust the level of flow restriction resulting from rotatable flow restrictor 1605.

FIG. 16 depicts a section cut of a rotatable flow restrictor 1605 installed within inflow pipe 120 and inflow standpipe 140. Rotatable flow restrictor 1605 may be used to restrict the flow of wastewater from inflow pipe 120 to inflow standpipe 140 or allow an open flow of wastewater from inflow pipe 120 to inflow standpipe 140, based on the position of rotatable flow restrictor 1605 within inflow standpipe 140. Further, rotatable flow restrictor 1605 may not be removeable after installation within inflow standpipe 140; however, the position of rotatable flow restrictor 1605 may be adjusted after rotatable flow restrictor 1605 has been installed in inflow standpipe 140. Rotatable flow restrictor 1605 may comprise a circular projection extending from a rotation cap 1610 that may be placed within inflow standpipe 140. The diameter of rotatable flow restrictor 1605 may correspond to the diameter of inflow standpipe 140, such that rotatable flow restrictor 1605 may be installed within inflow standpipe 140. Rotatable flow restrictor 1605 may comprise a flow restrictive portion 1615 and an open flow portion 1620. Flow restrictive portion 1615 may be of a length to extend into the opening between inflow pipe 120 and inflow standpipe 140. By extending into the opening between inflow pipe 120 and inflow standpipe 140, flow restrictive portion 1615 of rotatable flow restrictor 1605 may partially block the flow of wastewater from inflow pipe 120 into inflow standpipe 140. Open flow portion 1620 of rotatable flow restrictor 1605 may be located above the opening between inflow pipe 120 and inflow standpipe 140. Open flow portion 1620 may allow an unrestricted flow of wastewater from inflow pipe 120 to inflow standpipe 140.

Rotatable flow restrictor 1605 may further comprise at least one rotation knob 1625. In some embodiments, rotatable flow restrictor 1605 may comprise two rotation knobs 1625. Rotation knobs 1625 may comprise projections from the inner surface of rotatable flow restrictor 1605 located on opposite sides of rotatable flow restrictor 1605. Rotation knobs may comprise semi-circular, elliptical, rectangular, square, or any other shaped projection that may be suitable for allowing rotation of rotatable flow restrictor 1605. Rotation knobs 1625 may facilitate rotation of rotatable flow restrictor 1605 from a restrictive flow position to an open flow position or from an open flow position to a restrictive flow position after rotatable flow restrictor 1605 has been installed within inflow standpipe 140. Rotatable flow restrictor 1605 may further comprise a rotation cap 1610. Flow restrictive portion 1615 and open flow portion 1620 of rotatable flow restrictor 1605 may extend from the lower surface of rotation cap 1610. The diameter of rotation cap 1610 may correspond to the diameter of inflow standpipe 140 such that rotation cap 1610 may be installed on the circumference of inflow standpipe 140 to secure rotatable flow restrictor 1605 within inflow standpipe 140. Rotation cap 1610 may also allow rotatable flow restrictor 1605 to be rotated after installation within inflow standpipe 140 to provide flow restriction or open flow between inflow pipe 120 and inflow standpipe 140. Inflow standpipe cover 1630 may be installed over the opening of inflow standpipe 140 after rotatable flow restrictor 1605 is installed within inflow standpipe 140. Inflow standpipe cover 1630 may prevent the flow of wastewater from exiting from the upper opening of inflow standpipe 140. Inflow standpipe cover 1630 may further comprise opening 1635. Opening 1635 may comprise a hole through the top of inflow standpipe cover 1630. Opening 1635 may be circular in shape, as depicted in FIG. 16. In other embodiments, opening 1635 may be square, rectangular, polygonal, oval, or any other shape. Opening 1635 may facilitate the removal of inflow standpipe cover 1630 from inflow standpipe 140. Inflow standpipe cover 1630 may also be removeable from the opening of inflow standpipe 140 to allow for rotation of rotatable flow restrictor 1605 or for cleaning and maintenance of inflow standpipe 140.

Rotatable flow restrictor 1605 may further comprise a male detent feature 1640 and a female detent feature 1645. As depicted in FIG. 16, rotatable flow restrictor 1605 may comprise two male detent features 1640 and two female detent features 1645. In other embodiments, more or fewer male detent features 1640 and female detent features 1645 may be provided to allow for additional orientations of rotatable flow restrictor 1605. The size and shape of male detent feature 1640 may correspond to the size and shape of female detent feature 1645, such that female detent feature 1645 may lock into male detent feature 1640. When female detent feature 1645 is disconnected from male detent feature 1640, rotatable flow restrictor 1605 may rotate freely. Locking female detent feature 1645 into male detent feature 1640 may prevent the rotatable flow restrictor 1605 from rotating out of the correct orientation after adjustment.

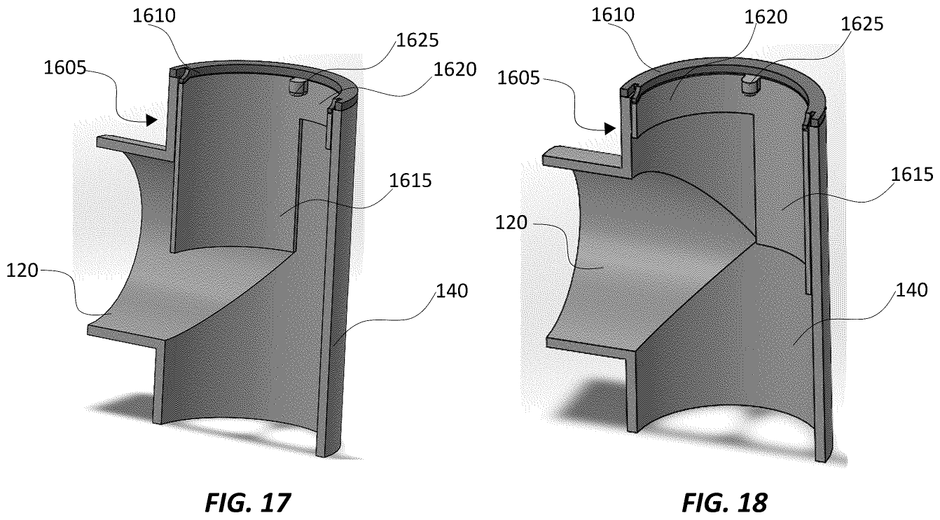

FIG. 17 depicts a section cut of rotatable flow restrictor 1605 installed in a flow restrictive position within inflow standpipe 140. As depicted in FIG. 17, flow restrictive portion 1615 of rotatable flow restrictor 1605 may be positioned to extend within the opening between inflow pipe 120 and inflow standpipe 140. In this position, the flow restrictive portion 1615 of rotatable flow restrictor 1605 may restrict the flow of wastewater between inflow pipe 120 and inflow standpipe 140 to provide a moderated flow of wastewater into the grease interceptor system. Alternatively, FIG. 18 depicts a section cut of rotatable flow restrictor 1605 installed in an open flow position within inflow standpipe 140. Rotatable flow restrictor 1605 may be rotated to a position in which open flow portion 1620 is located above the opening between inflow pipe 120 and inflow standpipe 140. In this position, open flow portion 1620 may not prevent the flow of wastewater between inflow standpipe 28 and inflow standpipe 140, allowing for an unrestricted flow of wastewater into the grease interceptor system. Although FIG. 17 and FIG. 18 depict rotatable flow restrictor 1605 in two discrete positions, rotatable flow restrictor 1605 may be rotated to any position within inflow standpipe 140.

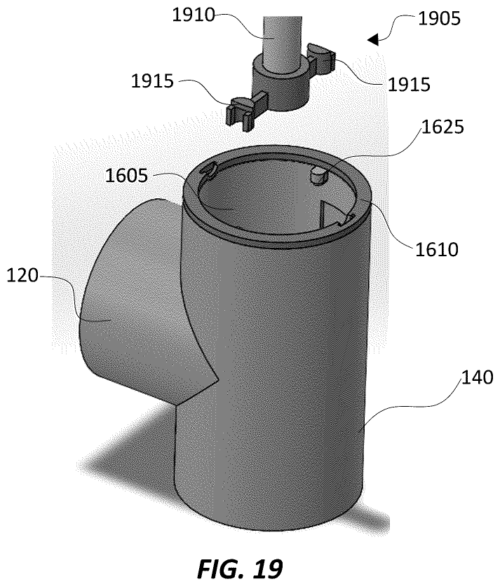

FIG. 19 depicts an adjustment tool 1905 which may be used to adjust the position of rotatable flow restrictor 1605. Adjustment tool 1905 may comprise a handle 1910 and two adjustment extensions 1915 extending from opposite sides of handle 1910. Handle 1910 may allow an end user to adjust rotatable flow restrictor 1605 after rotatable flow restrictor 1605 has been installed within inflow standpipe 140. Adjustment extensions 1915 may comprise a semi-circular, elliptical, square, rectangular, or any other shaped extension. Adjustment extensions 1915 may correspond to the size and shape of rotation knobs 1625 such that adjustment extensions 1915 may be placed around the outer perimeter of rotation knobs 1625 to adjust rotatable flow restrictor 1605. Rotatable flow restrictor 1605 may be rotated by placing adjustment extensions 1915 over rotation knobs 1625 and rotating handle 1910 180 degrees. Rotatable flow restrictor 1605 may be rotated within rotation cap 1610 by adjustment extensions 1915 of adjustment tool 1905 such that either flow restrictive portion 1615 or open flow portion 1620 is located at the opening between inflow pipe 120 and inflow standpipe 140 to allow for varying degrees of flow restriction into the grease interceptor system.

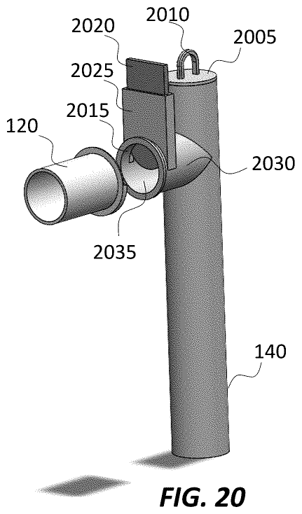

FIG. 20 depicts an adjustable flow restrictor plate 2020 installed within inflow standpipe 140. In such an embodiment, inflow standpipe 140 may comprise a horizontal extension 2030. Horizontal extension 2030 of inflow standpipe 140 may comprise a flow restrictor plate extension 2025. Flow restrictor plate extension 2025 may comprise a hollow vertical extension from horizontal extension 2030. The size and shape of flow restrictor plate extension 2025 may correspond to the size and shape of adjustable flow restrictor plate 2020, such that adjustable flow restrictor plate 2020 may be placed within flow restrictor plate extension 2025. Horizontal extension 2030 may further comprise a cutout corresponding to flow restrictor plate extension 2025 such that adjustable flow restrictor plate 2020 may extend through the cutout into the hollow interior 2035 of horizontal extension 2030 to restrict the flow of wastewater to inflow standpipe 140.

Adjustable flow restrictor plate 2020 may comprise a flat plate which may restrict the flow of wastewater into inflow standpipe 140. Adjustable flow restrictor plate 2020 may be placed within flow restrictor plate extension 2025 and may extend into hollow interior 2035 of horizontal extension 2030. Adjustable flow restrictor plate 2020 may be placed at any distance within hollow interior 2035 of horizontal extension 2030. For example, the lower that adjustable flow restrictor plate 2020 extends into hollow interior 2035 of horizontal extension 230, the more the flow of wastewater into inflow standpipe 140 is restricted. The higher the adjustable flow restrictor plate 2020 extends into hollow interior 2035 of horizontal extension 2030, the less the flow of wastewater into inflow standpipe 140 is restricted. Adjustable flow restrictor plate 2020 may be adjusted after installation into flow restrictor plate extension 2025 by raising or lowering adjustable flow restrictor plate 2020 within flow restrictor plate extension 2025.

Inflow pipe 120 may be connected to horizontal extension 2030 at connection point 2015. Inflow standpipe 140 may further comprise cap 2005, which may prevent wastewater from exiting through the top opening of inflow standpipe 140. Cap 2005 may also be removeable from inflow standpipe 140 to allow for cleaning and maintenance. Cap 2005 may be installed or removed from inflow standpipe 140 through use of handle 2010. Handle 2010 may extend vertically from the top of cap 2005 to allow for installation and removal of cap 2005 from inflow standpipe 140.

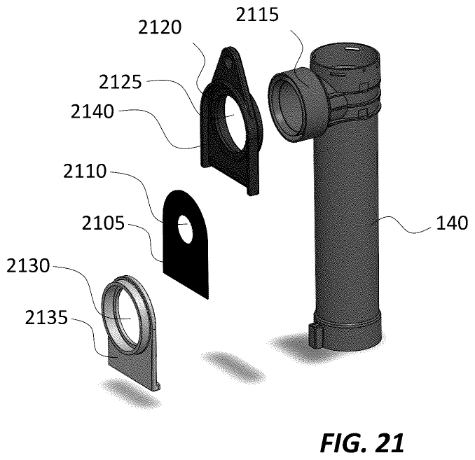

FIG. 21 depicts a non-adjustable flow restrictor plate 2105 for installation within an inflow standpipe 140. Inflow standpipe 140 may comprise a horizontal extension 2115. Inflow standpipe adapter 2120 may be attached to horizontal extension 2115 of inflow standpipe 140. Inflow standpipe adapter 2120 may comprise opening 2125. A diameter of opening 2125 may correspond to a diameter of horizontal extension 2115. Inflow standpipe adapter 2120 may further comprise a slotted edge 2140, which may facilitate the installation of non-adjustable flow restrictor plate 2105. Non-adjustable flow restrictor plate 2105 may be installed adjacent to inflow standpipe adapter 2120 and held in place by slotted edge 2140. Non-adjustable flow restrictor plate 2105 may comprise a flow restriction opening 2110. Flow restriction opening 2110 may comprise a diameter that is less than the diameter of opening 2125 and horizontal extension 2115. The flow of wastewater into inflow standpipe 140 may be restricted based on the smaller diameter of flow restriction opening 2110. Inflow pipe adapter 2130 may be attached to inflow standpipe adapter 2120 such that non-adjustable flow restrictor plate 2105 may be held between inflow pipe adapter 2130 and inflow standpipe adapter 140. An inflow pipe may be installed on inflow pipe adapter 2135 to allow the flow of wastewater to enter from an inflow pipe, through flow restriction opening 2110 of non-adjustable flow restrictor plate 2105, and then into inflow standpipe 140.

The invention, with explicit and implicit variations and advantages, has been described and illustrated with respect to several example embodiments. Those embodiments should be considered illustrative and not restrictive examples. Various changes, omissions and/or additions may be made. And equivalents may be substituted for elements or example embodiments. Unless specifically stated otherwise, any use of words such as “preferred” and variations suggest a feature or combination which is desirable but which is not mandatory. Thus, embodiments lacking any such preferred features or combinations may be within the scope of the claimed invention. Persons skilled in the art may make various changes in form and detail of the invention embodiments without departing from the spirit and scope of the claimed inventions.

What is claimed is:

1. An adjustable flow restrictor configured to regulate a flow of wastewater through an inflow standpipe of a grease interceptor, wherein the adjustable flow restrictor comprises:
a rotatable cap, wherein the rotatable cap comprises at least one handle configured to adjust the rotatable cap within the inflow standpipe; and
a flow restrictor projection extending from the rotatable cap into the inflow standpipe, wherein the flow restrictor projection comprises a curved projection configured to restrict the flow of wastewater within the inflow standpipe.

2. The adjustable flow restrictor of claim 1, wherein the rotatable cap further comprises a flow restriction indicator arrow configured to indicate a degree of flow restriction caused by the flow restrictor projection.

3. The adjustable flow restrictor of claim 2, wherein the flow restriction indicator arrow corresponds to a flow restriction percentage indicator on the inflow standpipe.

4. The adjustable flow restrictor of claim 3, wherein the flow restriction percentage indicator comprises numbers, dashes, notches, or shapes.

5. The adjustable flow restrictor of claim 1, wherein the rotatable cap further comprises a cap lock configured to secure the adjustable flow restrictor within an inflow standpipe lock.

6. The adjustable flow restrictor of claim 5, wherein the inflow standpipe lock comprises a channel extending around an interior circumference of the inflow standpipe.

7. The adjustable flow restrictor of claim 1, wherein the rotatable cap comprises two handles.

8. The adjustable flow restrictor of claim 1, wherein a diameter of the rotatable cap corresponds to a diameter of the inflow standpipe.

9. The adjustable flow restrictor of claim 1, wherein a diameter of the flow restrictor projection corresponds to a diameter of the inflow standpipe.

10. The adjustable flow restrictor of claim 1, wherein the flow restrictor projection extends around an interior circumference of the inflow standpipe.

11. A grease interceptor for treating wastewater by separating and retaining contaminants, wherein the grease interceptor comprises:
a tank having a top wall, a bottom wall, opposing side walls, an upstream end wall, and a downstream end wall;
a baffle extending transversely between the opposing side walls, dividing the tank lengthwise into a first chamber and a second chamber, wherein the baffle comprises at least one exit opening for discharge of wastewater from the first chamber into the second chamber;
an inflow pipe configured to direct wastewater from a source through an inflow standpipe to the first chamber;
an adjustable flow restrictor comprising a rotatable cap and a flow restrictor projection configured to regulate a flow of wastewater into the inflow standpipe; and
an outlet pipe configured to direct wastewater from the second chamber through an outlet standpipe to an outlet.

12. The grease interceptor of claim 11, wherein the rotatable cap of the adjustable flow restrictor further comprises a flow restriction indicator arrow configured to indicate a degree of flow restriction caused by the flow restrictor projection.

13. The grease interceptor of claim 12, wherein the flow restriction indicator arrow corresponds to a flow restriction percentage indicator on the inflow standpipe.

14. The grease interceptor of claim 13, wherein the flow restriction percentage indicator comprises numbers, dashes, notches, or shapes.

15. The grease interceptor of claim 11, wherein the rotatable cap further comprises a cap lock configured to secure the adjustable flow restrictor within an inflow standpipe lock.

16. The grease interceptor of claim 15, wherein the inflow standpipe lock comprises a channel extending around an interior circumference of the inflow standpipe.

17. The grease interceptor of claim 16, wherein the cap lock of the adjustable flow restrictor is configured to rotate within the channel of the inflow standpipe lock to adjust a level of flow restriction of the adjustable flow restrictor.

18. The grease interceptor of claim 16, wherein the flow restrictor projection extends around an interior circumference of the inflow standpipe.

19. The grease interceptor of claim 11, wherein a diameter of the rotatable cap corresponds to a diameter of the inflow standpipe.

20. The grease interceptor of claim 11, wherein a diameter of the flow restrictor projection corresponds to a diameter of the inflow standpipe.
